(19) United States
(12) Patent Application Publication
(10) Pub. No.: US 2007/0263758 A1
(43) Pub. Date: Nov. 15, 2007

(54) DEUTERIDE/HYDRIDE CATALYZED CONDENSATION ENERGY PRODUCTION

(76) Inventors: Richard A. Day, Crever, OH (US); Kenneth A. Rubinson, Bethesda, MD (US); Terrence McConville, Cincinnati, OH (US); Alfred Kornel, Cincinnati, OH (US)

Correspondence Address: WOOD, HERRON & EVANS, LLP, 2700 CAREW TOWER, 441 VINE STREET, CINCINNATI, OH, 45202, US

(21) Appl. No.: 11/743,471

(22) Filed: May 2, 2007

Related U.S. Application Data
(60) Provisional application No. 60/746,316, filed on May 3, 2006.

(51) Int. Cl. H05H 1/22

(52) U.S. Cl. 376/100

(57) ABSTRACT

A process is disclosed for the generation of energy achieved when an ionic hydride or deuteride is heated with certain elements capable of forming a covalent hydride or deuteride respectively.

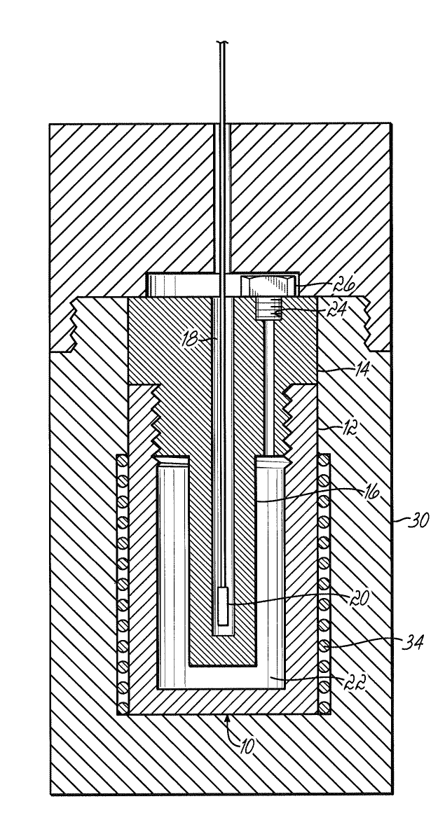

### RELATED APPLICATION

This application is related to provisional application Ser. No. 60/746,316, filed May 3, 2006, the disclosure of which is hereby incorporated by reference.

### FIELD OF THE INVENTION

The present invention relates to a catalyzed fusion process which allows the joint redistribution of the constituent particles between atomic nuclei at temperatures between 300 to 1500° C. and under easily controlled chemical conditions. More specifically, the present invention provides a process for the production of energy from a hydrogen (¹H and ²H) source wherein one form of the hydrogen/deuterium is present both as an ionic hydride/deuteride, H⁻/D⁻, in the presence of a covalent hydride/deuteride. The products of the reactions can be ³He, ⁴He, a ⁶Li, and ⁷Li, variously, and heat.

### BACKGROUND OF THE INVENTION

Nuclear fusion requires the joining together of atomic nuclei. Because the nuclei have strong positive electric charges, they repel each other strongly. Prior attempts assume that only by making the nuclei extremely energetic could one overcome this electrostatic repulsion—the “coulomb barrier”. “Hot fusion” is thought to achieve this result at high temperatures because the high speed of the nuclei overcomes the coulomb barrier. This high speed can also be achieved in particle accelerators. Fusion has generally been thought to occur only at high temperatures in stars, through the use of mega-electron-volt particle accelerators, in thermonuclear bombs, in magnetic-field confined high temperature plasmas, and in inertial confinement brought to fusion conditions with a high power laser.

The fusion of ¹H nuclei is the main source of energy in all stars. But on earth, ¹H is not a candidate for any fusion process. The processes for fusing deuterium and tritium in hydrogen bombs, in a Tokamak, or in laser driven implosions, are not considered applicable to protium (¹H).

Tunneling is the property where a particle can pass through a barrier to its motion, i.e., an energy barrier that it cannot surmount with any probability by passing over the barrier. Tunneling can occur at distances where the wave like properties of the nucleus can take effect. The de Broglie wavelength affords a measure of this distance. For a deuteron at 1200° K., the de Broglie wavelength is 0.56 Å; for a proton it is twice that, 1.1. Å.

That the tunneling for protium may be greater than for deuterium is suggested by the isotope effect on the tunneling rates of chemical reactions. The literature is replete with studies involving some aspect of ¹ H/²H tunneling effect comparisons. Very few are concerned with three particles simultaneously tunneling such as 3 ¹H or 3 ²H. In chemistry, triple proton transfer in an organic crystal has been studied (Aguiler-Parrilla, Klein, Equero and Limbach. Ber. 101,889-901 (1997); Limbach, Henning, Gerritzen and Rumpel, Faraday Dis. Chem Soc (1982) 74, 229-243). The results are consistent with there being a single barrier where all three protiums lose zero-point energy in the transition state; that is, the ions are not confined to harmonic wells. Strict comparisons between the reaction in the crystalline organic matrix and this application's environment cannot be made. However, the very large isotope effect of the rate of reaction—K_{HHH}/k_{DDD}=47—suggests that not only may the wave like overlap be larger for protium than deuterium, but the three-particle tunneling may be more probable as well.

### SUMMARY OF THE INVENTION

It is a primary object of the present invention to provide a process for facilitating a reaction in which hydrogen (¹H and ²H) nuclei condense to form ³He, ⁴He, ⁶Li and/or ⁷Li with the production of thermal energy. There are provided two processes for the production of energy, comprising: (1) bringing a mixture of a hydride/deuteride salt and an element capable of forming intermediate covalent hydrides/deuterides, and (2) bringing together a suitable element capable of forming an ionic hydride/deuteride under conditions of temperatures in the aforementioned temperature range of about 300 to about 1500° C. or higher and an element capable of forming intermediate covalent hydride/deuteride. The covalent hydride/deuteride acts as a catalyst for the nuclear condensation; the ionic hydride/deuteride is the other component of this two-catalyst system.

In a specific embodiment of the present invention, heat is produced by bringing a finely divided mixture of a solid hydride/deuteride salt and a catalytic element capable of forming covalent hydrides/deuterides or bringing together a metal capable of forming an ionic deuteride or hydride and a catalytic element that can form a covalent deuteride of hydride to a temperature of about 300 to about 1500° C. or higher in a sealed cell in an atmosphere of protium/deuterium gas. The preferred elements that form ionic hydrides are Groups I and II elements; the preferred elements are sodium and potassium. The preferred elements that form covalent hydrides are (in decreasing order of preference): Groups V, III, IV, VI and II. The preferred catalytic elements are antimony and germanium.

The objects and advantages of the present invention will be further appreciated in light of the following detailed description and drawings in which:

### BRIEF DESCRIPTION OF THE DRAWING

The Figure is a cross sectional depiction of a reaction vessel for use in the present invention.

### DETAILED DESCRIPTION

The process of the present invention is believed to be based on three hydrogen nuclei (¹H and/or ²H) in a compound approaching within nuclear tunneling distance.

Bringing together hydrogen nuclei to within tunneling distance (order of 0.5-2 Å) is accomplished by the collapse of a molecule. For example, the catalyst antimony with deuterium forms stibine, SbH₃, or stibine-3d, SbD₃, which goes to a highly condensed state by the agency of the interaction of a hydride/deuteride anion, H⁻/D⁻. As a result of this interaction, the D⁻or H⁻replaces an electron, e⁻. As with the muonic molecule, there is a collapse to species such as SbD₃(D), SbD₃(H), or SbH₃(H) where the three or four N/Ds are within tunneling distance some fraction of the time in the shrunken molecule. With three deuteriums, ⁶Li is the predominant product.

The production of ⁷Li from three deuteriums and one proton is also likely. A similar process for four deuteriums also can be anticipated to produce an unstable mass eight nucleus, ⁸Li or ⁸Be. The ⁸Li with a half life of 0.855 s decays to 2α+aβ; both have energies at ˜13 MeV. The β energy would be dissipated as Cerenkov radiation. The ⁸Be would immediately dissociate into two ⁴He nuclei.

Five nuclear reactions are possible. (Abbreviations: using: p=¹H and d=²H).

| | | | |
|---|---|---|---|
| Ia | 4p → ⁴H + heat | Ib | 4d → ⁴H + heat |
| | | IIb | 3d → ³H + ³He + heat |
| IIIa | 3p → ³He + heat | IIIb | 3d → ⁶Li + heat |
| | | IVb | 3d + p → ⁷Li + heat |
| | | Vb | 3d → ⁴He + d + heat |

We have no evidence that reaction IIb occurs since no trace of ³H is found.

It is postulated that the reactions occur in three stages. The first is the formation of a covalent hydride/deuteride, e.g., p₃-stibine or d₃-stibine:
3H₂+2Sb→2SbH₃; 3D₂+2Sb→2SbD₃

The second stage is a muon-like exchange of a H⁻/D⁻ for an e⁻ in the Sb-d₃-stibine:
D⁻+2SbD₃=SbD₄+e⁻ H⁻+Sb H₃≈SbH₄+e⁻

Third, this exchange leads to collapse of the SbH₄/SbD₄ to a more compact form. Then the protiums/deuteriums are brought even closer through a transition state upon going from one geometry to its inverse. It is postulated that during the inversion of the configuration of the protons/deuterons in the compact, collapsed form, the nuclei come within tunneling distance. A certain fraction undergo fusion by a process involving one or more of the indicated reactions: Reaction Ia, Ib; Reaction IIIa, IIIb, or Reaction IVb. No high energy radiation escapes the hermetically sealed cell during heat production with deuterium fusion, nor is any detectable amount of a radioactive product produced when the cell contents are examined.

This process is facilitated/catalyzed by any element that forms a covalently bonded deuteride. This two-fold catalysis is a function of a covalent hydride/deuteride in the presence of an ionic hydride/deuteride, H⁻/D⁻, produced from a suitable ionic deuteride salt. The elements most useful for production of H⁻/D⁻ are the alkali metals. The preferred elements are sodium and potassium. Any element that can form a covalent hydride/deuteride can be used as a catalyst, but those preferred are from Group IIIa, IVa, Va. From the latter groups, the preferred elements are boron, germanium, and antimony.

Any catalyst must exhibit a suitable set of properties. Among these, importantly, is a useful temperature dependence. Any process that produces energy from nuclear processes has the potential for going to high temperatures. Thus, the likelihood of a runaway reaction must be addressed. Under usable conditions, antimony exhibits the property of being effective over a limited temperature range, 950° to 1050° C.

Between 950° C. and above 1050° C. there is evidence of the fusion process occurring. This limitation may be ascribed to the thermal instability of one of the catalytic components, stibine (SbH₃) or deuterostibine (SbD₃), or any more complex hydride or deuteride that may function as a catalyst.

The same desirable properties discussed for antimony apply here. However, germanium exhibits significantly different properties. It is known to form higher molecular weight clusters involving more than one Ge atom at temperatures above 1100° C. [Chambreau and Zhang, Chem. Phys. Lett. 351, 171-177, (2002)]. This is in accord with our observation that when germanium is used as a catalyst, temperatures rapidly rise above the melting point of stainless steel (˜1450). Thus, with Ge, reaction vessels need to be made of higher melting alloys to avoid container failure.

Hydride/deuteride salts useful in the present invention include all that have an ionic character of the alkali metal hydrides/deuterides—lithium hydride/deuteride, sodium hydride/deuteride and potassium hydride/deuteride—sodium hydride/deuteride is preferred. These salts can contain various trace metals without significantly affecting the process. However, it is preferred that the hydride/deuteride salt be substantially free of other anions. As used herein, “substantially free” means that the deuteride salt contains no more than about 10 mole percent of any anions in question. The hydride/deuteride salt may be present in any physical form. However, the liquid form is preferred.

The reaction is conducted in a sealed, inert high pressure reaction cell 10. The reaction cell 10 is formed from high-temperature metal alloys such as high-temperature super alloys. The reaction vessel 10 includes a main reaction chamber 12 having an internally threaded opening and an upper externally threaded cap 14. Cap 14 has a central member 16 having a hollow cylindrical well 18 adapted to receive a thermocouple 20. Between the main chamber 12 and the cap 14 is a reaction zone 22. The cap 14 threads onto the reaction chamber 12. Cap 14 includes an internally threaded opening 24 which extends into reaction zone 22 and is sealed by a high-temperature machine screw 26. In use, the reaction vessel is surrounded by a silica/titania or alumina insulating block 30 which includes a nichrome heating element 34. This is then held in an air-tight chamber (not shown).

Analyses of the reaction cells' contents after the heating indicated that in some cases the catalyst had reacted slowly with the stainless steel. A variety of metals had been shown to be resistant to such corrosion. Further, lithium antimonide, a highly refractory material, was stable under the reaction conditions. By changing the cell material and/or lining of the interior of the cell with one of the stable materials, the reaction cell will preserve high levels of the catalyst and the cell's integrity. Permeation of the stainless steel by deuterium or hydrogen under the reaction conditions is slow (over the period of many hours). Preferably, a less permeable material is utilized such as Haynes 230®, as well as other high temperature superalloys.

Other materials which can be used as the reaction vessel may include Haynes® 188, 242, 282, 214, 556, HR 160®, HR 120® and HR556. Other high temperature alloys include type 330 stainless, RA 85H alloy, Pyromet® Alloy 600 and 601, Super Wasp Alloy, Pyromet Alloy 625 and 680.

In practicing the process of the present invention, two general procedures may be followed. In the first procedure a mixture of the hydride/deuteride salt and the catalytic element in a finely divided form are mixed thoroughly and, if necessary, further pulverized together. The molar ratio of hydride/deuteride salt to catalyst should be 10 to 1. This powder is loaded into the reaction zone 22 under an atmosphere of argon. The reaction chamber 12 is capped tightly with cap 14. The head space is swept out with about ten volumes of argon through a hypodermic needle inserted through the opening 24 in the cap. Then, the head space is swept out with about ten volumes of hydrogen/deuterium gas. The cap 14 is blanketed with flowing argon while machine screw 26 is inserted, sealing opening 24. After tightening at high torque both the cap 14 and the machine screw 26, the junctures between the cap and the cell and the machine screw 26 and the cap 14 are TIG welded in order to hermetically seal the reaction cell 10. The molar ratio of hydrogen/deuterium to hydride/deuteride should be 0.001 to 0.01.

In the second procedure, the reaction zone 22 is loaded with the catalytic element such as antimony and the reactive metal of choice (i.e., Na, K, Mg). The head space is swept out again with several volumes of argon followed with several volumes of hydrogen or deuterium. While the orifice is blanked with flowing argon, machine screw 26 is inserted into opening 24. The reaction chamber 12 is capped tightly with cap 14. Both the cap 14 and machine screw 26 are tightened and both are TIG welded in order to hermetically seal the reaction cell. The reactive metals of choice are the alkali metals; the preferred metal is sodium.

The molar ratio of catalytic element to reactive metal to hydrogen/deuterium should be catalyst, 0.01 M reactive metal 0.1 M, hydrogen/deuterium 0.001 to 0.002 M.

For both procedures, the sealed cell is placed in a cavity in a block of insulating silica/titanium oxide or alumina 30 equipped with a heating coil 34. A thermocouple 20 is inserted in well 18 in the cap 14 of the cell 10. The cavity is flushed with argon and maintained under argon. The cell 10 is then heated to the 300-1100° C. range and the temperature reported by the TC is recorded for the duration of the run and during the cooling period. The cell 10 is opened by drilling through the cell wall in order to analyze the contents after the heat production period.

The data in Table 1 was obtained using both procedures, or experiments 1 and 2, respectively. In these experiments, the following reactants were employed Na, NaH and Sb. In each of these procedures, the temperature increased from 950 to 1050° C. over 2-12 hours, and then cooled.

In Table 1, the data shows a good correlation between theory and experiment. That is, the amount of ⁶Li formed from deuterium/deuteride predicts a theoretical number of joules; the experimental result shows a good agreement between the observed heat generated and that predicted from Reactions IIIa and IIIb.

Also, Table 1 contains data that shows a fair to good correlation between the amount of ⁶Li produced with sodium, hydrogen and antimony and the excess heat produced. The observed heat produced, and the theoretical heat produced by converting 3D to 1 ⁶Li are compared. Also included in Table 1 are analyses of the Na and Sb used in the experiment prior to heating. Also included is analysis of the reagent nitric acid used as a sample diluent. The insoluble residue remaining in the cell after heating was also analyzed. Likewise, the stainless steel was also analyzed to rule out inadvertent contamination.

TABLE 1
Examples of correlation of observed heat production with Na,
D₂, and Sb with theoretical heat of mass to energy conversion

| | Amount | Theoretical Joules | Observed |
|---|---|---|---|
| EXPERIMENTS^{a} | ⁶Li formed | 3d ^{→ 6}Li^{c} | Joules |
| Procedure 1 | 21 ng-atoms | 50,700 | 57,300 |
| Procedure 2 | 36 ng-atoms | 86,400 | 93,300 |
| CONTROLS | ng-atoms | | |
| Nitric acid reagent^{b} | 0.0025 | — | — |
| Sodium^{b} | 0.0025 | — | — |
| Residue | 0.0022 | — | — |
| Sb^{c} | 0.0156 | — | — |
| Stainless steel^{d} | 0.0093 | — | — |

^{a}all diluted to same volume where applicable.
^{b}used to dilute the reaction mixture in experiments 1 and 2 tenfold.
^{c}an amount of material was used equivalent to that used in experiments 1 and 2.
^{d}250 mg drilled out of this reaction vessel used in experiment 2. Dissolved in aqua regia.

The first procedure (above) was used to generate the data shown in Table 2. Whereas NaD/Na give ⁶Li (Table 1), a boron catalyst gives predominantly ⁴He and little or no ⁵Li. In other words, a number of different catalysts are effective, but the fusion products depend on the catalyst's identity.

TABLE 2
Protium/Deuterium Conversion to ³He and
⁴He with Boron and Germanium Catalysts

| | | Amount^{a} of Product |
|---|---|---|
| Catalysts/Reactants Products | | ng-atoms |
| B/NaH/H₂ | ³He | 0.15 |
| | ⁴He | 0.067 |
| Ge/NaH/H₂ | ³He | 1.4 |
| | ⁴He | 0.56 |
| NaBD₄/D₂ | ³He | 0.077 |
| (B/D) | ⁴He | 0.30 |
| | ⁶Li | trace |
| | ⁷Li | trace |

^{a}³He and ⁴He were measured mass spectrometrically. Standard mixtures of ⁴He and H₂ were made up in helium-free argon, the helium levels measured against a standard mixture. It is assumed that the ionization efficiency of ³He and ⁴He are the same within experimental error.

The cell shown in the Figure is utilized to generate energy. This can be accomplished in a variety of different ways. If the cell and its contents are heated while maintaining elevated pressure, the reaction will be self-sustaining. The reaction can then be controlled by use of heat exchangers which will maintain the temperature at acceptable levels, generally below 1500° C. and above 900-1000° C. Thus, the reaction will be self-sustaining and the heat removed can be used as an energy source.

Alternately, at lower temperatures, where the reaction is not self-sustaining, i.e., below 900° C. and above 300° C., a non-self-sustaining reaction will occur. Thus, the reaction chamber can be placed in a heated area, such as within a power plant, to boost energy output. The reaction chamber would simply be placed in proximity to the burners from the power plant, or other heat source from the power plant, so that the external temperature of the chamber exceeds 300° C., preferably about 650° C., causing the fusion reaction to occur and, in turn, increasing the energy output from the power plant.

Thus, the present invention provides a process for using protium/deuterium in the presence of a hydride/deuteride to produce energy. The description fully satisfies the objects, aspects, and advantages set forth. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations, which fall within the spirit and scope of the following claims.

This has been a description of the present invention along with the preferred method of practicing the present invention. However, the invention itself should only be defined by the appended claims.

1. A process for the production of energy, comprising bringing a hydride or deuteride salt, catalytic element, and hydrogen or deuterium gas contained in a hermetically sealed cell to a temperature effective to produce heat within the cell.

2. The process claimed in claim 1 wherein said temperature is 300 to 1500° C.

3. The process according to claim 1 wherein the hydride or deuteride salt is a salt of at least one alkali metal.

4. The process according to claim 1 wherein the hydride or deuteride salt is a salt of at least one alkaline earth metal.

5. The process according to claim 3 wherein the hydride or deuteride salt is a lithium salt.

6. The process according to claim 1 comprising combining in said cell a metal which can form an ionic deuteride or hydride, an element that can form a covalent hydride or deuteride, and deuterium, and further forming said hydride or deuteride salt in said cell.

7. The process according to claim 1 wherein the cell is made of a heat resistant alloy.

8. The process claimed in claim 1 wherein said catalytic element is selected from the group consisting of antimony, boron, and germanium.

9. The process claimed in claim 1 wherein a molar ratio of catalytic element to hydride to deuteride salt ranges from 0.01 to 0.1.
